(19) United States
(12) Patent Application Publication
(10) Pub. No.: US 2016/0288148 A1
(43) Pub. Date: Oct. 6, 2016

(54) VALVE GUN FOR A HIGH-PRESSURE CLEANER

(71) Applicant: Alfred Kärcher GmbH & Co. KG, Winnenden (DE)

(72) Inventors: Christoph Breuer, Fellbach (DE); Daniel Knoedler, Auenwald (DE)

(73) Assignee: Alfred Kärcher GmbH & Co. KG

(21) Appl. No.: 15/178,212

(22) Filed: Jun. 9, 2016

Related U.S. Application Data
(63) Continuation of application No. PCT/EP2013/076457, filed on Dec. 12, 2013.

(51) Int. Cl. B05B 12/00; B05B 1/30; B05B 9/01

(52) U.S. Cl. CPC B05B 12/002; B05B 9/01; B05B 1/3026

(57) ABSTRACT

A valve gun for a high-pressure cleaner is provided, including a housing and a valve arranged therein having a closing body that lies tight against a valve seat in a closed position and is adapted to be acted upon by a valve plunger with an opening force, and including a triggering lever pivotable about a first pivot axis, the triggering lever mechanically coupled to the valve plunger and manually pivotable from a rest to a release position. The triggering lever is coupled to the valve plunger via a coupling lever pivotable about a second pivot axis, the coupling lever having an actuating element via which the valve plunger is adapted to be acted upon with the opening force, and first and second force receiving elements, the first adapted to be acted upon first and subsequently the second with a triggering force upon pivoting the triggering lever to the release position.

### CROSS-REFERENCE TO RELATED APPLICATIONS

This application is a continuation of international application number PCT/EP2013/076457 filed on Dec. 12, 2013, which is incorporated herein by reference in its entirety and for all purposes.

### BACKGROUND OF THE INVENTION

The invention relates to a valve gun for a high-pressure cleaner, comprising a housing and a valve which is arranged in the housing and has a closing body which in a closed position lies tight against a valve seat and is adapted to be acted upon by a valve plunger with an opening force for moving the closing body into an open position at a distance from the valve seat, and comprising a triggering lever mounted so as to be pivotable about a first pivot axis, the triggering lever being mechanically coupled to the valve plunger and manually pivotable from a rest position in which the closing body assumes its closed position to a release position in which the closing body assumes its open position.

The discharge of liquid which has been pressurized by a high-pressure cleaner can be controlled by such valve guns. A pressure hose, for example, can be connected to an inlet of the valve, and a spray lance, for example, can be connected to an outlet of the valve. Pressurized liquid can be supplied to the valve gun via the pressure hose, and the liquid can be directed at an object via the spray lance. To control the discharge of the liquid, the user has the possibility of pivoting the triggering lever from a rest position to a release position. The triggering lever is mechanically coupled to a valve plunger. An opening force can be directed by the valve plunger at the closing body of the valve so that the closing body lifts off from the valve seat against the pressure of the liquid acting in the rest position on the closing body and thereby releases a flow connection from the inlet of the valve to the outlet of the valve. In addition to the pressure of the liquid, the force of a return spring usually acts upon the closing body to ensure that after the liquid has been discharged, the closing body automatically assumes its closed position again provided that the user releases the triggering lever.

As mentioned above, the closing body transfers from the closed position to the open position against the pressure of the liquid. Therefore, a considerable opening force must be exerted on the closing body to open the valve, and a not inconsiderable holding force must be exerted on the closing body to hold the closing body in the open position. The actuating forces which the user must exert on the triggering lever are correspondingly large. This makes handling of the valve gun difficult.

To reduce the actuating forces, in particular, for opening the valve, it is proposed in DE 35 18 492 to pivot the triggering lever from the rest position firstly about a first pivotal point and subsequently about a second pivotal point. The first pivotal point is arranged at a shorter distance from the valve plunger than the second pivotal point. The short distance of the first pivotal point from the valve plunger has the consequence that when opening the valve, a large opening force can first be exerted on the valve plunger and from the valve plunger on the closing body of the valve, however, with only a relatively short displacement path of the valve plunger being achievable. When the triggering lever is pivoted further, its pivotal point changes. The second pivotal point is at a larger distance from the valve plunger and so the opening force achievable by the user is lower, but a larger displacement path can now be achieved. The valve gun known from DE 35 18 492 is, therefore, characterized by improved handling, however, the provision of two pivotal points for the triggering lever requires considerable constructional expenditure.

To reduce the constructional expenditure, a valve gun is proposed in EP 0 408 865 A2, in which a displacement movement is superimposed on the pivotal movement of the triggering lever. The pivot axis of the triggering lever is held in an elongate hole and changes its position when the triggering lever is pivoted.

A valve gun is described in DE 196 14 663 A1, in which an actuating part is displaceably mounted in the triggering lever and can be pivoted in between the valve plunger and a support roller. In the release position of the triggering lever, the actuating part is supported on the support roller.

A valve gun is described in DE 35 27 922, in which, in addition to a triggering lever, a lock lever is used, which in the release position of the triggering lever supports the triggering lever and thereby reduces the actuating force to be exerted by the user to hold the closing body in the open position.

Valve guns have also been proposed, in which the triggering lever is coupled to the valve plunger via a toggle lever (GB 513 013 A) or via a multipart lever mechanism (EP 2 165 768 B1), in order to thereby simplify handling of the valve gun. However, this requires considerable constructional expenditure.

A valve gun is known from EP 1 389 495 A1, in which the actuating force required to open the valve is reduced by a piston acted upon by the pressure of the liquid prevailing upstream of the valve seat lying against the triggering lever. The piston is mounted in a displaceable and sealed manner in a channel.

The object of the present invention is to further develop a valve gun of the kind mentioned at the outset in such a way that it has a simple constructional design, is easy to handle and has low susceptibility to failure.

### SUMMARY OF THE INVENTION

This object is accomplished in a valve gun of the generic kind, in accordance with the invention, in that the triggering lever is coupled to the valve plunger via a coupling lever mounted so as to be pivotable about a second pivot axis, the coupling lever having an actuating element via which the valve plunger is adapted to be acted upon with the opening force, and the coupling lever having a first and a second force receiving element, the first force receiving element being adapted to be acted upon first and the second force receiving element subsequently with a triggering force when the triggering lever is pivoted from the rest position to the release position, the first force receiving element being at a greater distance from the second pivot axis than the second force receiving element.

In the valve gun in accordance with the invention, the triggering lever is coupled to the valve plunger via a coupling lever mounted so as to be pivotable about a second pivot axis. The coupling lever has an actuating element via which the valve plunger can be acted upon with the opening force. To pivot the coupling lever about the second pivot axis, it can be acted upon with a triggering force. For this purpose, the coupling lever has a first force receiving element and a second force receiving element. The first force receiving element is arranged at a greater distance from the second pivot axis than the second force receiving element. When the triggering lever is pivoted from its rest position to its release position, the coupling lever is first acted upon via the first force receiving element with a triggering force, and when the triggering lever is pivoted further, the coupling lever is acted upon via the second force receiving element with a triggering force. The lever ratios of the coupling lever, therefore, change with the transition from the rest position to the release position of the triggering lever. In a first phase of the transition, owing to the favorable lever ratio resulting from the large distance between the first force receiving element and the second pivot axis, a large opening force can be exerted on the valve plunger even though the user only acts upon the triggering lever with a relatively low actuating force. The large distance between the first force receiving element and the second pivot axis has the consequence that during the first phase of the pivotal movement of the triggering lever, only a small stroke of the valve plunger, i.e., only a relatively short displacement path of the valve plunger, can be achieved. However, this relatively small stroke is sufficient to lift the closing body off the valve seat of the valve to such an extent that the pressure of the liquid upstream of the valve seat is reduced to a considerable extent. In a second phase of the pivotal movement of the triggering lever, the coupling lever is then acted upon via the second force receiving element, which is at a shorter distance from the second pivot axis than the first force receiving element. The shorter distance of the second force receiving element has the consequence that a larger displacement path of the valve plunger can be achieved and so the closing body of the valve can be transferred to a relatively large distance from the valve seat.

The distance of the closing body from the valve seat, in the open position of the closing body, is expediently at least 1 mm. Flow losses of the liquid can thereby be kept low.

The valve gun in accordance with the invention is characterized by easy handling as the user only has to exert a relatively low actuating force on the triggering lever and yet the valve plunger can be acted upon with a high opening force. The force ratios are determined in a constructionally simple way by the configuration of the coupling lever, via which the triggering lever is coupled to the valve plunger. The valve plunger is acted upon with the opening force by the coupling lever via its actuating element. The distance of the actuating element from the second pivot axis can be small. In particular, it may be provided that the distance of the actuating element from the second pivot axis is approximately one tenth of the distance of the first force receiving element from the second pivot axis.

The distance of the second force receiving element from the second pivot axis is expediently approximately 40% to 80% in particular, approximately 65% to 75% of the distance of the first force receiving element from the second pivot axis.

It may be provided that at least one further mechanical coupling element is arranged between the triggering lever and the coupling lever.

In order to keep the constructional expenditure particularly low, it is advantageous for a triggering force to be directly exertable on the coupling element by the triggering lever. For this purpose, it may be provided that the first force receiving element and the second force receiving element are positionable on the triggering lever.

In an advantageous configuration, the triggering lever has a first and a second force application element, the first force receiving element of the coupling lever being positionable on the first force application element of the triggering lever, and the second force receiving element of the coupling lever being positionable on the second force application element of the triggering lever. When the triggering lever is pivoted from its rest position to its release position, the first force receiving element of the coupling lever first contacts the first force application element of the triggering lever so that the coupling lever is pivoted about the second pivot axis and thereby acts upon the valve plunger with a large opening force. After completion of the first phase of the pivotal movement of the triggering lever, the second force receiving element of the coupling lever contacts the second force application element of the triggering lever so that the pivotal movement of the coupling lever is continued, with a lower opening force now being exerted on the valve plunger by the actuating element of the coupling lever, but the valve plunger being able to be displaced a considerable distance.

In a preferred configuration of the invention, it is provided that the first force receiving element and the first force application element form a first guide surface and a first contact element contacting the first guide surface and movable along the first guide surface, and that the second force receiving element and the second force application element form a second guide surface and a second contact element contacting the second guide surface and movable along the second guide surface.

In order to keep the actuating force required to lift the closing body off the valve seat of the valve, which the user must exert on the triggering lever, particularly low, it is advantageous for the angle of inclination of the tangent of the first guide surface at the momentary contact point of the first contact element in relation to a first reference line oriented perpendicularly to a connecting line between the momentary contact point of the first contact element and the first pivot axis to be smaller than the angle of inclination of the tangent of the second guide surface at the momentary contact point of the second contact element in relation to a second reference line oriented perpendicularly to a connecting line between the momentary contact point of the second contact element and the first pivot axis. In such a configuration of the invention, when the triggering lever is pivoted from the rest position to the release position, the first contact element first moves along the first guide surface, with the first contact element contacting the first guide surface, and the second contact element subsequently moves along the second guide surface, with the second contact element contacting the second guide surface. The first guide surface is constructed such that the tangent of the first guide surface at the momentary contact point at which the first contact element contacts the first guide surface when it moves along the first guide surface is at an incline to a first reference line. The second guide surface is constructed such that the tangent of the second guide surface at the momentary contact point at which the second contact element contacts the second guide surface when it moves along the second guide surface is at an incline to a second reference line. The angle of inclination between the tangent of the first guide surface and the first reference line is smaller than the angle of inclination between the tangent of the second guide surface and the second reference line. The first reference line is oriented perpendicularly to a connecting line which connects the momentary contact point of the first contact element to the first pivot axis. The second reference line is oriented perpendicularly to a connecting line which connects the momentary contact point of the second contact element to the first pivot axis. During the first phase of the pivotal movement of the triggering lever, the first contact element moves along the first guide surface, and via the first guide surface and the first contact element, a first triggering force is transferred from the triggering lever onto the coupling lever. During the second phase of the pivotal movement of the triggering lever, the second contact element moves along the second guide surface, and via the second guide surface and the second contact element, a second triggering force is transferred from the triggering lever onto the coupling lever. The smaller angle of inclination of the tangent of the first guide surface has the consequence that during the first phase of the pivotal movement of the triggering lever, the coupling lever is moved only slightly. The triggering lever can, therefore, be pivoted during the first phase of its pivotal movement with relatively little force against the coupling lever. During the second phase of the pivotal movement, the coupling lever is moved to a greater extent owing to the larger angle of inclination of the tangent of the second guide surface, and so a considerable lift of the closing body can be achieved. The angle of inclination between the tangent of the first guide surface at the momentary contact point of the first contact element and the first reference line is decisive for the extent of the movement of the coupling lever in the first phase of the pivotal movement of the triggering lever. With an angle of inclination of 0°, a pivotal movement of the triggering lever would result in no movement of the coupling lever. The larger the angle of inclination, the greater is the extent of the movement of the coupling lever.

The inclination of the tangent of the first guide surface at the momentary contact point of the first contact element in relation to the first reference line may be, for example, approximately 10° to 45°, in particular, approximately 15° to 30°.

The inclination of the tangent of the second guide surface at the momentary contact point of the second contact element in relation to the second reference line may be, for example, 40° to 70°, in particular, 45° to 65°.

The first guide surface and/or the second guide surface may be curved, in particular, arcuately curved.

In a preferred embodiment of the invention, the first guide surface and the second guide surface are of flat configuration. In such an embodiment, the two guide surfaces each form an inclined plane along which the first contact element and the second contact element, respectively, move when the triggering lever is pivoted. The first guide surface forms in combination with the first contact element a first wedge gear, and the second guide surface forms in combination with the second contact element a second wedge gear. The triggering lever is mechanically connected to the coupling lever via the two wedge gears.

The first guide surface and/or the second guide surface are preferably aligned parallel to the second pivot axis.

It is expedient for the first guide surface and the second guide surface to be arranged on the triggering lever, and for the first contact element and the second contact element to be arranged on the coupling lever.

Alternatively, it may also be provided that the first guide surface and the second guide surface are arranged on the coupling lever and the first contact element and the second contact element are arranged on the triggering lever.

In an advantageous embodiment of the invention, the first contact element and/or the second contact element are configured as freely rotatable contact rollers.

The contact rollers may, for example, be rotatably mounted on the coupling lever.

In a preferred configuration of the invention, the first guide surface and the second guide surface are arranged at a side of the triggering lever that faces the coupling lever.

The first and the second guide surfaces are advantageously arranged at a side of the triggering lever that faces away from the first pivot axis.

When the closing body of the valve is in its open position, pressurized liquid flows around it and, expediently, it is, in addition, acted upon with a closing force by a closing spring of the valve. The user must, therefore, act upon the triggering lever with a certain holding force in order to hold the closing body in its open position. This may cause user fatigue. To achieve improved handling of the valve gun, it is desirable to reduce the necessary holding force. For this purpose, provision is made, in an advantageous embodiment of the invention, for the second contact element, in the release position of the triggering lever, to lie against a support surface, with the angle of inclination of the tangent of the support surface in relation to a third reference line oriented perpendicularly to a connecting line between the support surface and the first pivot axis being smaller than the angle of inclination of the tangent of the second guide surface at the momentary contact point of the second contact element in relation to the second reference line. As mentioned above, owing to the provision of the second guide surface and the second contact element, during the second phase of the pivotal movement of the triggering lever, a relatively large displacement path of the valve plunger can be achieved. The angle of inclination of the tangent of the second guide surface preferably has in relation to the second reference line a relatively large value, in particular, a value of at least approximately 45°. When the closing body reaches its open position at the end of the pivotal movement of the triggering lever, further displacement movement of the valve plunger is no longer necessary and the closing body can then be held in its open position. For this purpose, in the release position of the triggering lever, the second contact element can assume a position at a support surface. The inclination of the support surface to a third reference line is smaller than the inclination of the tangent of the second guide surface to the second reference line. The third reference line is oriented perpendicularly to a connecting line which connects the support surface to the first pivot axis. The smaller the angle of inclination of the tangent of the support surface in relation to the third reference line, the lower is the holding force which the user must exert on the triggering lever. If the angle of inclination is 0°, the support surface is aligned perpendicularly to the connecting line between the support surface and the first pivot axis, and so the coupling lever can be supported via the second contact element on the triggering lever, with the force exerted by the coupling lever on the triggering lever being directed at the first pivot axis and being received by the first pivot axis. Therefore, with an angle of inclination of the tangent of the support surface in relation to the third reference line of 0°, the user does not have to exert any force at all on the triggering lever in order to hold the closing body of the valve in its open position. This does, however, have the consequence that the closing body remains in its open position even when the user inadvertently puts the valve gun down. In such a case, in order to prevent the closing body from remaining in its open position, it is expedient for the angle of inclination of the tangent of the support surface in relation to the third reference line to be about 1° to approximately 20°, in particular, about 5° to 15°.

The support surface is expediently of flat configuration.

The second coupling element is preferably arranged on the coupling lever, and the support surface is arranged on the triggering lever.

It is expedient for the support surface to be arranged at the side of the triggering lever that faces the coupling lever.

It is advantageous for the support surface to be arranged between the first guide surface and the second guide surface. In such a configuration, both the first and second guide surfaces and the support surface are arranged at the side of the triggering lever that faces the coupling lever. Here the support surface assumes a position between the first guide surface and the second guide surface.

In an advantageous configuration of the invention, the coupling lever is of straight-lined configuration.

Alternatively, it may be provided that the coupling lever is of L-shaped configuration.

A further simplification of the handling of the valve gun is achieved in an advantageous embodiment of the invention by the valve having a valve inlet and a valve outlet, the valve outlet protruding from a front side of the housing of the valve gun, and by the housing having a grip graspable by the user with his hand, the triggering lever, in its rest position, protruding from a rear side of grip that faces away from the valve outlet. In such a configuration of the valve gun in accordance with the invention, the user can actuate the triggering lever with the heel of his hand. When pressurized liquid is discharged by the valve gun, the liquid exerts a recoil on the valve gun. The positioning of the triggering lever at the rear side of the grip that faces away from the valve outlet has the consequence that the valve gun is pressed against the heel of the user's hand under the influence of the recoil of the liquid. The heel of the user's hand, consequently, acts in the manner of an abutment against which the valve gun is supported. The user's fingers are, therefore, relieved.

It is expedient for the grip to protrude from a central or rear region of the housing of the valve gun and for the first pivot axis to be arranged in an end region of the grip that faces away from the central or rear region of the housing.

The central housing region expediently receives at least partially the coupling lever, via which the triggering lever is coupled to the valve plunger.

The housing of the valve gun is expediently formed by two housing shells on which the coupling lever and/or the triggering lever are pivotably mounted.

It is particularly advantageous for the coupling lever to be pivotably mounted on a valve housing of the valve.

To prevent inadvertent pivoting of the triggering lever from the rest position to the release position, the valve gun comprises, in an advantageous embodiment of the invention, at least one locking member which is movable back and forth between a first position and a second position, the triggering lever being lockable in the first position and releasable in the second position by the at least one locking member.

The valve gun preferably comprises a first and a second locking member which are each movable back and forth between a first position and a second position.

It is expedient for at least one locking member to be movably, in particular, displaceably or pivotably, mounted on a grip, graspable by the user with his hand, of the housing.

It is particularly advantageous for a locking member, in the first position, to protrude from a front side of the grip that faces the valve outlet. When the user grasps the grip of the housing with his hand, he can intuitively move the locking member arranged at the front side of the grip from the first position into the second position, and so the user can then pivot the triggering lever from the rest position to the release position in order to discharge pressurized liquid via the valve outlet.

Alternatively or additionally, it may be provided that a locking member is movably, in particular, displaceably, mounted on a region of the triggering lever which, in the rest position of the triggering lever, protrudes from the grip, the locking member, in its first position, protruding from the triggering lever, and, in its second position, extending fully into the triggering lever. In its first position, the locking member blocks movement of the triggering lever in the direction towards the grip, and in the second position of the locking member, the triggering lever can be moved in the direction towards the grip. The locking member may, for example, be mounted on the triggering lever so as to be displaceable parallel to the first pivot axis. The triggering lever preferably has in its region protruding from the grip in the rest position a through-hole in which the locking member is displaceably mounted.

The following description of advantageous embodiments of the invention will serve in conjunction with the drawings for further explanation.

### BRIEF DESCRIPTION OF THE DRAWINGS

FIG. 1 shows a schematic side view of a first advantageous embodiment of a valve gun;

FIG. 2 shows a sectional view of the valve gun taken along line 2-2 in FIG. 1, with a locking member assuming a first position;

FIG. 3 shows a sectional view corresponding to FIG. 2, with the locking member assuming a second position;

FIG. 4 shows a schematic sectional view of the valve gun from FIG. 1, with a triggering lever assuming a rest position;

FIG. 5 shows a schematic sectional view of the valve gun from FIG. 1, with the triggering lever assuming an intermediate position;

FIG. 6 shows a schematic sectional view of the valve gun from FIG. 1, with the triggering lever assuming a release position;

FIG. 7 shows a schematic sectional view of a second advantageous embodiment of a valve gun, with a triggering lever assuming a rest position;

FIG. 8 shows a schematic sectional view of the valve gun from FIG. 7, with the triggering lever assuming an intermediate position; and

FIG. 9 shows a schematic sectional view of the valve gun corresponding to FIG. 7, with the triggering lever assuming a release position.

### DETAILED DESCRIPTION OF THE INVENTION

A first advantageous embodiment of a valve gun in accordance with the invention is shown schematically in FIGS. 1 to 6 and denoted therein in its entirety by reference numeral 10. The valve gun 10 comprises a housing 12, which is formed by a first housing shell 14 and a second housing shell 15. The housing 12 has a central housing region 16 arranged between a front housing region 18 and a rear housing region 22. The front housing region 18 accommodates a valve 20, and a grip 24, from the free end region 26 of which a guard bracket 28 extends to the front housing region 18, protrudes from the rear housing region 22. The guard bracket 28, the central housing region 16 and the grip 24 surround a grip opening 30 which the user can engage with his fingers when grasping the grip 24.

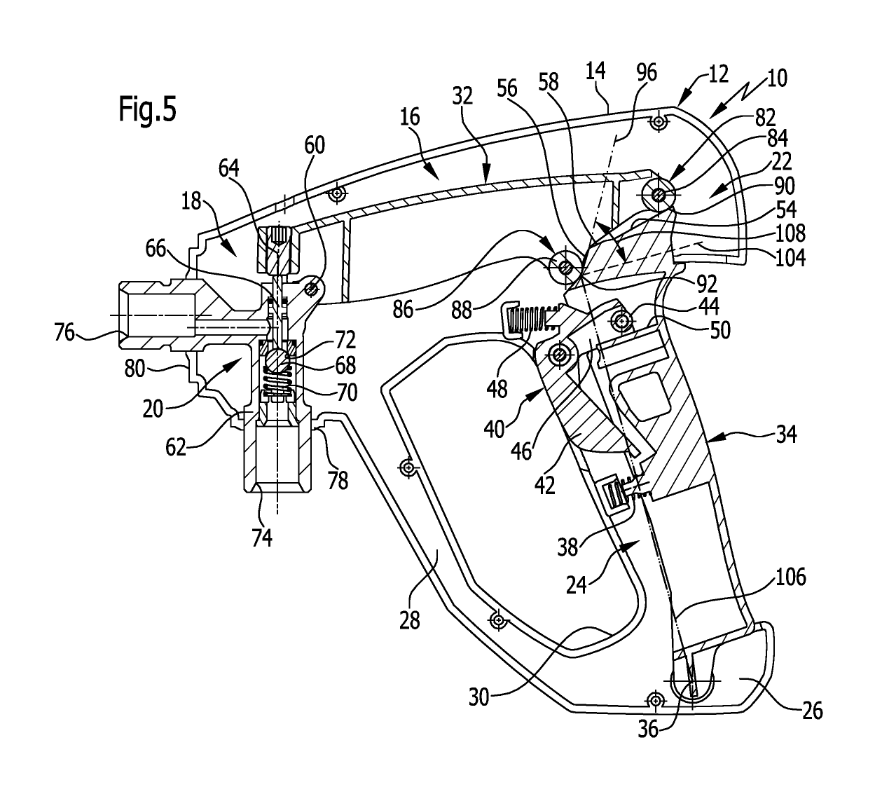

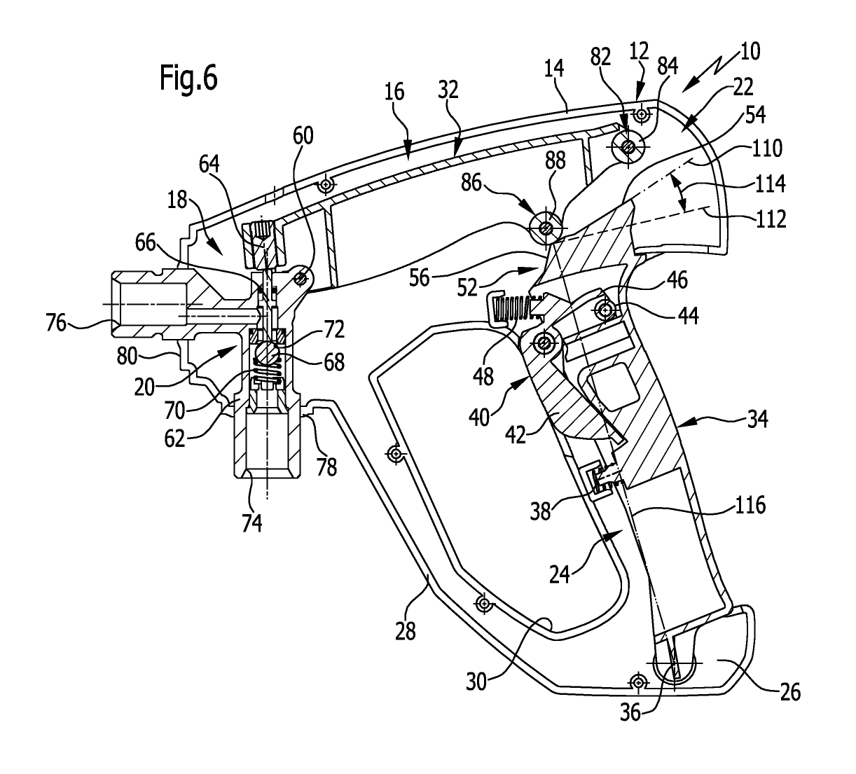

The central housing region 16 accommodates a substantially straight-lined coupling lever 32, and arranged in the grip 24 is a triggering lever 34. The triggering lever 34 is mounted on the two housing shells so as to be pivotable about a first pivot axis 36 and can be pivoted by the user with the heel of his hand from a rest position shown in FIGS. 1 to 4 via an intermediate position shown in FIG. 5 to a release position shown in FIG. 6. The first pivot axis 36 is arranged in the free end region 26 of the grip 24. In its rest position, the triggering lever 34 protrudes with a rear lever region 37 from the rear side of the grip 24 that faces away from the valve 20.

The triggering lever 34 is acted upon by a first return spring 38 with a spring-elastic reset force.

The triggering lever 34 can be locked in its rest position shown in FIGS. 1 to 4. For this purpose, a substantially L-shaped first locking member 40 is pivotably mounted on the grip 24, and a bolt-like second locking member 41 is mounted so as to be displaceable parallel to the first pivot axis 36 in the rear lever region 37.

A first leg 42 of the first locking member 40 protrudes in the first position of the first locking member 40 shown in FIGS. 1 to 4 from the front side of the grip 24 that faces the valve 20, and a free end 44 of a second leg 46 of the first locking member 40 lies, in the first position of the first locking member 40, against the triggering lever 34 and prevents pivotal movement thereof.

When the user grasps the grip 24 with his hand, with his fingers he intuitively pivots the first locking member 40 against the spring-elastic reset force of a second return spring 48 to a second position shown in FIGS. 5 and 6, in which the second leg 46 of the first locking member 40 extends into a recess 50 of the triggering lever 34, and so the triggering lever 34 can be pivoted from its rest position to its release position. When the user releases the grip 24 again, the triggering lever 34 is automatically pivoted by the first return spring 38 to its rest position, and the first locking member 40 is automatically pivoted by the second return spring 48 to its first position, and so the triggering lever 34 is locked again.

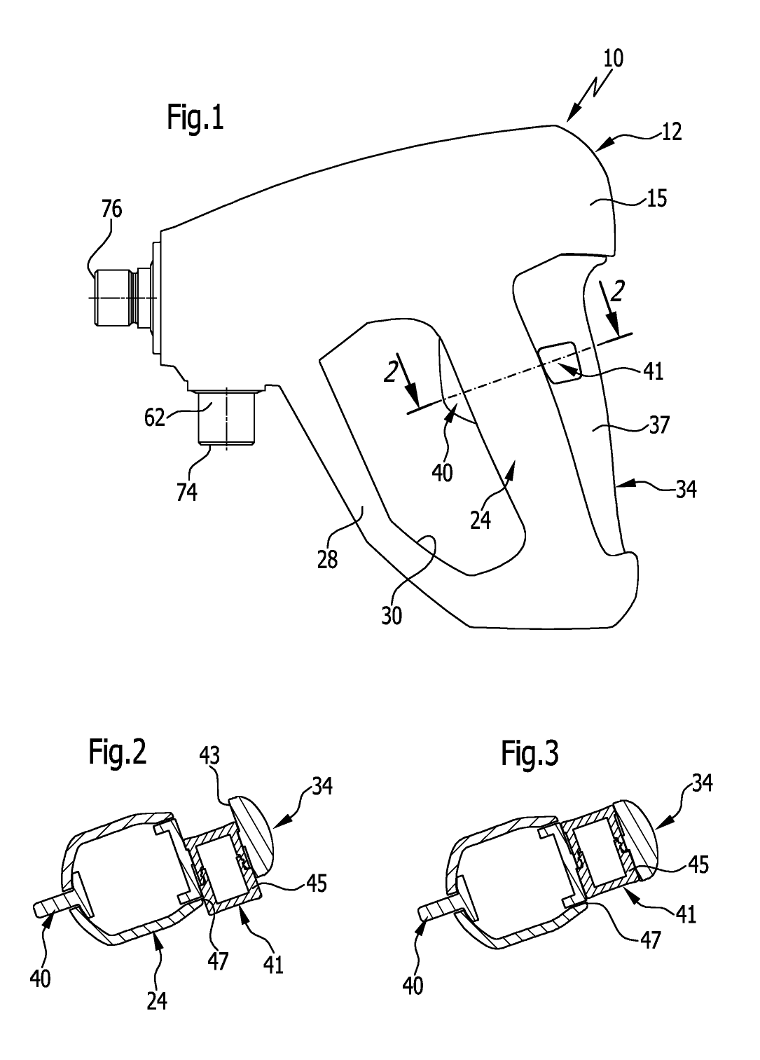

The second locking member 41 is mounted in a through-opening 43 so as to be displaceable back and forth between a first position shown in FIG. 2 and a second position shown in FIG. 3 parallel to the first pivot axis 36. The through-opening 43 is arranged in the rear lever region 37 of the triggering lever 34 and, therefore, in the rest position of the triggering lever 34, protrudes from the rear side of the grip 24. In this position, the second locking member 41, which is constructed in the manner of a bolt, can be moved into the first position in which it protrudes with a partial region 45 from the through-opening 43 and lies against a rear edge 47 of the grip 24. The triggering lever 34 is thereby blocked and cannot be pivoted from its rest position to its release position. To release the triggering lever 34, the second locking member 41 must be fully pushed into the through-opening 43 so that the second locking member 41 releases the rear edge 47 of the grip 24. In this second position, the triggering lever 34 can then be pivoted to the release position without being impeded by the second locking member 41.

The triggering lever 34 has at its end face 52 facing away from the first pivot axis 36 and facing the coupling lever 32 a first force application element in the form of a first flat guide surface 54 and a second force application element in the form of a second flat guide surface 56, and arranged between the first guide surface 54 and the second guide surface 56 at the end face 52 of the triggering lever 34 is a flat support surface 58.

The coupling lever 32 is pivotable about a second pivot axis 60 in the housing 12. The second pivot axis 60 is aligned parallel to the first pivot axis 36 and arranged on a valve housing 62 of the valve 20. At a short distance from the second pivot axis 60, the coupling lever 32 has an adjustable actuating element 64 which lies against a valve plunger 66. The valve plunger 66 is mounted for displacement in the valve housing 62 and lies with its end facing away from the actuating element 64 against a spherical closing body 68 of the valve 20, which is acted upon by a third return spring 70 with a spring-elastic closing force in the direction towards a valve seat 72.

The valve housing 62 has a valve inlet 74 and a valve outlet 76. The valve inlet 74 protrudes from an underside 78 of the front housing region 18 and the valve outlet 76 protrudes from a front side 80 of the front housing region 18. A liquid supply line, for example, a pressure hose, can be connected to the valve inlet 74, and pressurized liquid can be supplied to the valve gun 10 via the liquid supply line. A spray lance, for example, can be connected to the valve outlet 76, and the pressurized liquid can be discharged via the spray lance.

The valve seat 72 is arranged in the flow path between the inlet 74 and the outlet 76. When the closing body 68 is in its closed position shown in FIG. 1, it lies tight against the valve seat 72, and so the flow connection between the valve inlet 74 and the valve outlet 76 is interrupted. In its closed position, the closing body 68 is acted upon by the pressure of the liquid prevailing upstream of the valve seat 72. By means of the valve plunger 66, the closing body 68 can be lifted off the valve seat 72 against the reset force of the third return spring 70 and against the pressure of the liquid acting on the closing body 68, so that it releases the flow connection between the valve inlet 74 and the valve outlet 76. The liquid pressure prevailing upstream of the valve seat 72 in the closed position of the closing body 68 is thereby reduced.

The coupling lever 32 has at its end facing away from the actuating element 64 a first force receiving element in the form of a first contact element 82 which, in the illustrated embodiment, is configured as first contact roller 84 freely rotatably mounted on the coupling lever 32.

At a distance from the first contact element 82, the coupling lever 32 has on its underside facing the grip 24 a second force receiving element in the form of a second contact element 86 which, in the illustrated embodiment, is configured as second contact roller 88 freely rotatably mounted on the coupling lever 32. The distance of the second contact roller 88 from the second pivot axis 60 is smaller than the distance of the first contact roller 84 from the second pivot axis 60. Expediently, the distance of the second contact roller 88 from the second pivot axis 60 is approximately 40% to 80% of the distance of the first contact roller 84 from the second pivot axis 60.

The distance between the actuating element 64 and the second pivot axis 60 is preferably about 10% of the distance between the first contact roller 84 and the second pivot axis 60.

In the rest position of the triggering lever 34, the first contact roller 84 can lie against the first guide surface 54 of the triggering lever 34. The region of the first guide surface 54 in which the first contact roller 84 momentarily contacts the first guide surface 54 forms a momentary first contact point 90.

When the triggering lever 34 is pivoted from its rest position about the first pivot axis 36, the first contact roller 84 rolls along the first guide surface 54 until the first contact roller 84 reaches the rear end of the first guide surface 54 that faces away from the support surface 58. With the change in position of the first contact roller 84, the position of the momentary first contact point 90 also changes. During this first phase of the pivotal movement of the triggering lever 34, the coupling lever 32 is pivoted about the second pivot axis 60 to such an extent that the closing body 68 is lifted off the valve seat 72 and, as a result, the pressure of the liquid prevailing upstream of the valve seat 72 is reduced.

When the first contact roller 84 reaches the rear end of the first guide surface 54 that faces away from the valve 20, as shown in FIG. 2, the second contact roller 88 then contacts the front end of the second guide surface 56 that faces the valve 20. The region of the second guide surface 56 in which the second contact roller 88 momentarily contacts the second guide surface 56 forms a momentary second contact point 92. When the triggering lever 34 is pivoted further to its release position, the second contact roller 88 rolls along the second guide surface 56, and the coupling lever 32 is pivoted further about the second pivot axis 60 and thereby displaces the valve plunger 66 so that the closing body 68 finally assumes a significant distance from the valve seat 72.

When the triggering lever 34 reaches its release position shown in FIG. 3, the second contact roller 88 assumes a position on the support surface 58. This is shown in FIG. 3.

The first guide surface 54 forms, as well as the second guide surface 56, an inclined plane. The first guide surface 54 has a first tangent 94 at the first contact point 90, and the second guide surface 56 has a second tangent 96 at the second contact point 92. In relation to a first reference line 98 oriented perpendicularly to a first connecting line 100 connecting the first contact point 90 to the first pivot axis 36, the first tangent 94 is inclined at a first angle of inclination 102. The second tangent 96 is inclined at a second angle of inclination 108 in relation to a second reference line 104 oriented perpendicularly to a second connecting line 106 connecting the second contact point 92 to the first pivot axis 36. The first angle of inclination 102 is significantly smaller than the second angle of inclination 108. For example, it may be provided that the first angle of inclination is 10° to 40°, in particular, 15° to 30°, whereas the second angle of inclination is, for example, 40° to 70°, in particular, 45° to 65°.

Since the first angle of inclination 102 is chosen smaller than the second angle of inclination 108, during a first phase of the pivotal movement of the triggering lever 34, the coupling lever 32 is pivoted about a relatively small pivot angle as long as the first contact roller 84 rolls on the first guide surface 54, and, subsequently, during a second phase of the pivotal movement of the triggering lever 34, the coupling lever 32 is pivoted about a larger pivot angle, as long as the second contact roller 88 rolls on the second guide surface 56. The consequence of the larger distance between the first contact roller 84 and the second pivot axis 60 in combination with the smaller angle of inclination 102 is that the user needs only to exert a relatively low actuating force on the triggering lever 34 to open the valve 20. This facilitates the handling of the valve gun 10. During the first phase of the pivotal movement of the triggering lever 34, the closing body 68 is lifted off the valve seat 72 to such an extent that the pressure of the liquid prevailing upstream of the valve seat 72 is considerably reduced, and, subsequently, the closing body 68 can be moved further into its open position with less opening force by the second contact roller 88 rolling on the second guide surface 56.

When the triggering lever 34 reaches its release position shown in FIG. 3, in which the closing body 68 assumes its open position, the coupling lever 32 is supported via the second contact roller 88 on the support surface 58. The flat support surface 58 has a third tangent 110 which in relation to a third reference line 112 has a third angle of inclination 114 which is smaller than the second angle of inclination 108. The third reference line 112 is oriented perpendicularly to a third connecting line 116 connecting the support surface 58 to the first pivot axis 36. The third angle of inclination 114 is preferably smaller than the first angle of inclination 102. It is expedient for the third angle of inclination 114 to be about 1° to approximately 20°, in particular, about 5° to 15°.

Owing to the relatively small inclination of the support surface 58 to the third reference line 112, only a relatively low holding force needs to be exerted by the user on the triggering lever 34 to hold the closing body 68 in its open position. The handling of the valve gun 10 is, therefore, very easy, in particular, the valve gun 10 can be actuated by the user with low forces.

Actuation of the valve gun 10 without fatigue is also facilitated by the triggering lever 34 being arranged at the rear side of the grip 24 that faces away from the valve 20 as the valve gun 10 is thereby pressed into the palm of the user's hand grasping the grip 24 under the influence of the recoil of the liquid discharged via the valve outlet 76.

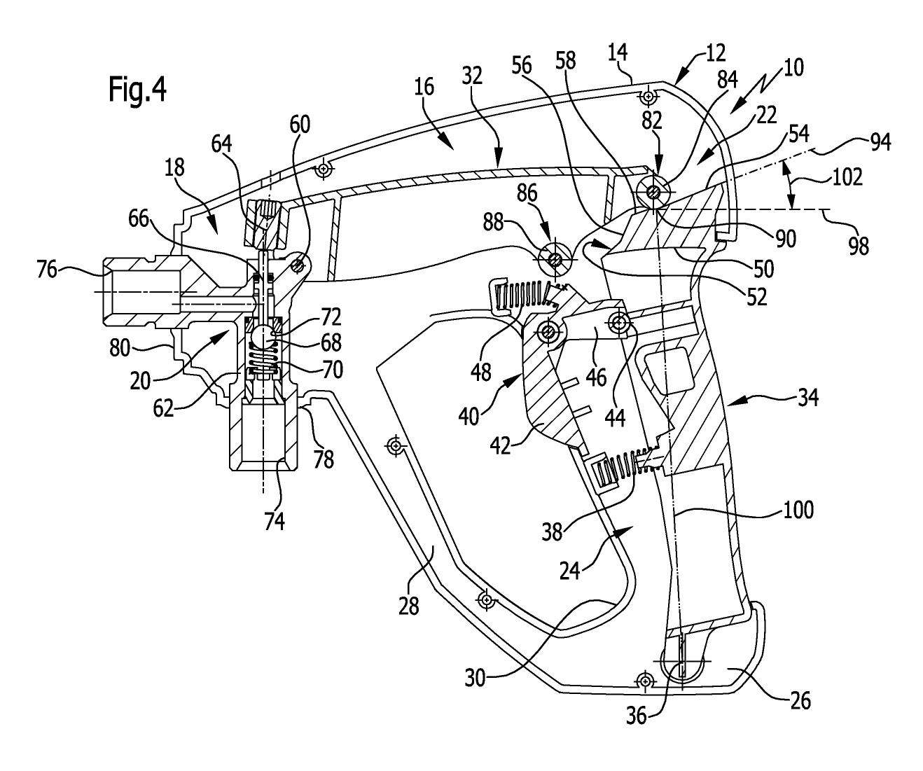

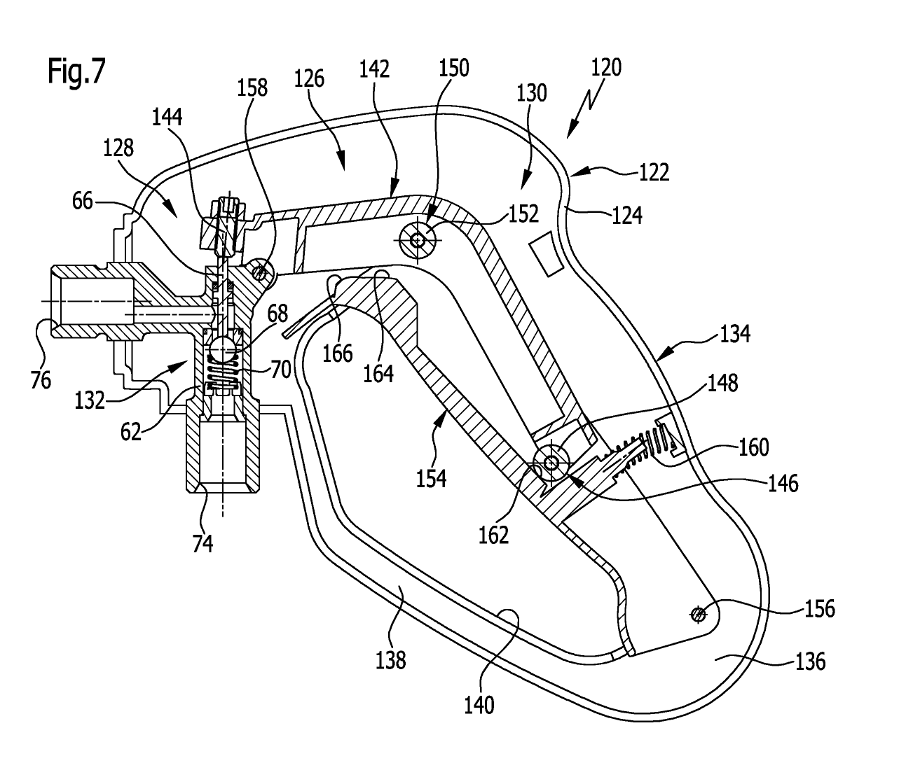

A second advantageous embodiment of a valve gun in accordance with the invention is shown schematically in FIGS. 7, 8 and 9 and denoted therein in its entirety by reference numeral 120. The valve gun 120 comprises a housing 122 which is formed by a first housing shell 124 and a second housing shell not shown in the drawings. The housing 122 has a central housing region 126 arranged between a front housing region 128 and a rear housing region 130. The front housing region 126 accommodates a valve 132 which is identical in configuration to the valve 20 explained hereinabove with reference to FIGS. 4 to 6. Therefore, to avoid repetitions, the same reference numerals will be used for individual parts of the valve 132 as for the valve 20, and with regard to these individual parts reference is made to the above explanations in order to avoid repetitions.

Protruding from the rear housing region 130 is a grip 134, from the free end region 136 of which a guard bracket 138 extends to the front housing region 128. The guard bracket 138, the central housing region 126 and the grip 134 surround a grip opening 140 which the user can engage with his fingers when grasping the grip 134.

Extending from the central housing region 126 into the region of the grip 134 is an L-shaped coupling lever 142 which carries an actuating element 144 at its front end facing the valve 132 and immediately adjacent to the actuating element 144 is pivotably mounted on a housing of the valve 132. At its rear end region facing away from the valve 132, the coupling lever 142 has a first force receiving element in the form of a first contact element 146 which, in the illustrated embodiment, is configured as first contact roller 148 freely rotatably mounted on the coupling lever 142.

Approximately halfway between the actuating element 144 and the first contact element 142, the coupling lever 142 has a second force receiving element in the form of a second contact element 150 which, in the illustrated embodiment, is configured as second contact roller 152 freely rotatably mounted on the coupling lever 142.

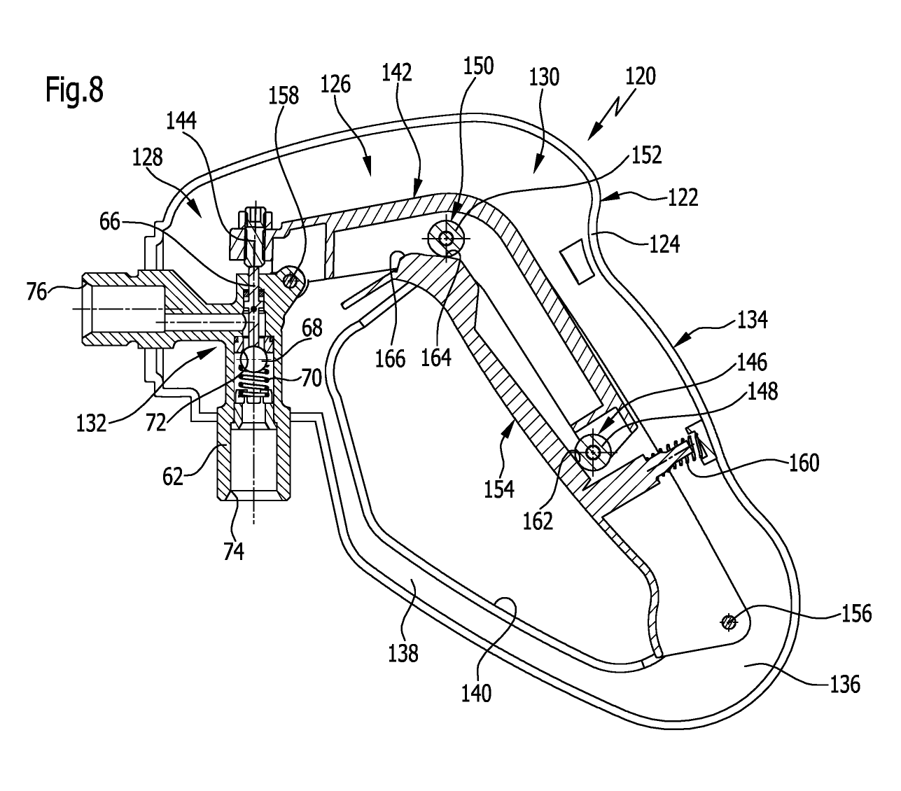

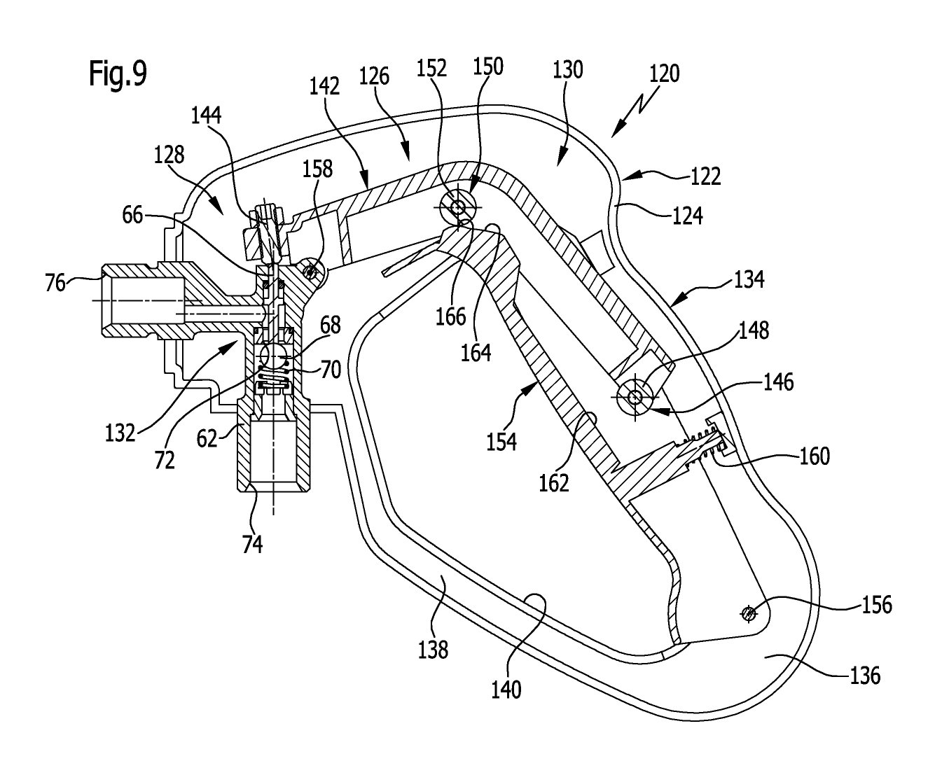

In the grip 134, a triggering lever 154 is mounted on the two housing shells so as to be pivotable about a first pivot axis 156 and can be pivoted by the user with his fingers from the rest position shown in FIG. 7 via the intermediate position shown in FIG. 8 to a release position shown in FIG. 9. The first pivot axis 156 is arranged in the end region 136 of the grip 134 that faces away from the central housing region 128. The first pivot axis 156 is oriented parallel to a second pivot axis 158 about which the coupling lever 142 is pivotable relative to the valve 132.

In the embodiment shown in FIGS. 7, 8 and 9, the triggering lever 154, therefore, protrudes in its rest position from the front side of the grip 134 that faces the valve 132 and can be pivoted by the user into the grip 134.

The triggering lever 154 is acted upon with a spring force in the direction of the rest position by a reset spring 160. The reset spring 160 is clamped between the housing 122 and the triggering lever 154.

In the rest position of the triggering lever 154, the first contact roller 148 lies against a first force application element in the form of a first guide surface 162 of the triggering lever 154. The first guide surface 162 is arranged on the rear side of the triggering lever 154 that faces away from the grip opening 140.

Associated with the second contact roller 152 is a second force application element in the form of a second guide surface 164, which the triggering lever comprises in its front end region facing away from the first pivot axis 156. When the triggering lever 154 is pivoted from its rest position about the first pivot axis 156, the first contact roller 148 rolls along the first guide surface 162, the coupling lever 142 is pivoted about the second pivot axis 158 and, as a result, the closing body of the valve 132 lifts off from the associated valve seat and the pressure of the liquid prevailing upstream of the valve seat is reduced.

During the first phase of the pivotal movement of the triggering lever 154, the second guide surface 164 approaches increasingly the second contact roller 152, which reaches the second guide surface 164 in the intermediate position shown in FIG. 8. During further pivoting of the triggering lever 154, the first contact roller 148 lifts off from the first guide surface 162, and the second contact roller 152 rolls along the second guide surface 164. During this, the coupling lever 142 is pivoted further about the second pivot axis 158, and so the closing body of the valve 132 assumes an increasing distance from the valve seat.

When the triggering lever 154 reaches its release position shown in FIG. 9, the second contact roller 152 assumes a position on a support surface 166 adjoining the second guide surface 164.

The distance of the first contact roller 148 from the second pivot axis 158 is significantly larger than the distance of the second contact roller 152 from the second pivot axis 158. This has the consequence that with a relatively low actuating force which the user exerts on the triggering lever 154, a very strong triggering force can be exerted by the coupling lever 152 on the valve plunger of the valve 132. However, in this first phase of the pivotal movement of the triggering lever 154 only a relatively small stroke of the valve plunger can be achieved. A considerably larger stroke is achieved in the second phase of the pivotal movement of the triggering lever 154 in which the second guide surface 164 lies against the second contact roller 152.

At least one locking member by means of which the triggering lever 154 can be locked in its rest position is also used in the second advantageous embodiment of a valve gun in accordance with the invention shown in FIGS. 7, 8 and 9. The locking member is not shown in FIGS. 7, 8 and 9 merely to achieve a better overview. The locking member may, for example, be held movably, in particular, pivotably or displaceably, on the housing 122 between a first position in which it lies against the triggering lever 154 and a second position in which it releases the triggering lever 154.

Owing to the different lever ratios achieved in the first and the second phase of the pivotal movement of the triggering lever 154, the handling of the valve gun 120 is very easy, in particular, the valve gun 120 can be actuated by the user with low forces.

1. A valve gun for a high-pressure cleaner, comprising a housing and a valve which is arranged in the housing and has a closing body which in a closed position lies tight against a valve seat and is adapted to be acted upon by a valve plunger with an opening force for moving the closing body into an open position at a distance from the valve seat, and comprising a triggering lever mounted so as to be pivotable about a first pivot axis, the triggering lever being mechanically coupled to the valve plunger and manually pivotable from a rest position in which the closing body assumes its closed position to a release position in which the closing body assumes its open position, wherein the triggering lever is coupled to the valve plunger via a coupling lever mounted so as to be pivotable about a second pivot axis, the coupling lever having an actuating element via which the valve plunger is adapted to be acted upon with the opening force, and the coupling lever having a first and a second force receiving element, the first force receiving element being adapted to be acted upon first and the second force receiving element subsequently with a triggering force when the triggering lever is pivoted from the rest position to the release position, the first force receiving element being at a greater distance from the second pivot axis than the second force receiving element.

2. The valve gun in accordance with claim 1, wherein the first force receiving element and the second force receiving element are positionable on the triggering lever.

3. The valve gun in accordance with claim 1, wherein the triggering lever has a first and a second force application element, the first force receiving element being positionable on the first force application element, and the second force receiving element being positionable on the second force application element.

4. The valve gun in accordance with claim 3, wherein the first force receiving element and the first force application element form a first guide surface and a first contact element contacting the first guide surface and movable along the first guide surface, and wherein the second force receiving element and the second force application element form a second guide surface and a second contact element contacting the second guide surface and movable along the second guide surface.

5. The valve gun in accordance with claim 4, wherein the angle of inclination of the tangent of the first guide surface at the momentary contact point of the first contact element in relation to a first reference line oriented perpendicularly to a connecting line between the momentary contact point of the first contact element and the first pivot axis is smaller than the angle of inclination of the tangent of the second guide surface at the momentary contact point of the second contact element in relation to a second reference line oriented perpendicularly to a connecting line between the momentary contact point of the second contact element and the first pivot axis.

6. The valve gun in accordance with claim 4, wherein the first guide surface and the second guide surface are of flat configuration.

7. The valve gun in accordance with claim 6, wherein at least one of the first guide surface and the second guide surface is aligned parallel to the second pivot axis.

8. The valve gun in accordance with claim 4, wherein the first guide surface and the second guide surface are arranged on the triggering lever, and wherein the first contact element and the second contact element are arranged on the coupling lever.

9. The valve gun in accordance with claim 4, wherein at least one of the first contact element and the second contact element is configured as freely rotatable contact roller.

10. The valve gun in accordance with claim 4, wherein the first guide surface and the second guide surface are arranged at a side of the triggering lever that faces the coupling lever.

11. The valve gun in accordance with claim 10, wherein the first guide surface and the second guide surface are arranged at a side of the triggering lever that faces away from the first pivot axis.

12. The valve gun in accordance with claim 4, wherein the second contact element, in the release position of the triggering lever, lies against a support surface, with the angle of inclination of the tangent of the support surface in relation to a third reference line oriented perpendicularly to a connecting line between the support surface and the first pivot axis being smaller than the angle of inclination of the tangent of the second guide surface at the momentary contact point of the second contact element in relation to the second reference line.

13. The valve gun in accordance with claim 12, wherein the angle of inclination of the tangent of the support surface in relation to the third reference line is 1° to 20°, in particular, 5° to 15°.

14. The valve gun in accordance with claim 12, wherein the support surface is of flat configuration.

15. The valve gun in accordance with claim 12, wherein the support surface is arranged at the side of the triggering lever that faces the coupling lever.

16. The valve gun in accordance with claim 15, wherein the support surface is arranged between the first guide surface and the second guide surface.

17. The valve gun in accordance with claim 1, wherein the coupling lever is of straight-lined or L-shaped configuration.

18. The valve gun in accordance with claim 1, wherein the valve has a valve inlet and a valve outlet, the valve outlet protruding from a front side of the housing, and wherein the housing has a grip graspable by the user with his hand, the triggering lever, in its rest position, protruding from a rear side of the grip that faces away from the valve outlet.

19. The valve gun in accordance with claim 1, wherein the housing has a grip graspable by the user with his hand, which protrudes from a central or rear region of the housing, and wherein the first pivot axis is arranged in an end region of the grip that faces away from the central or rear region of the housing.

20. The valve gun in accordance with claim 19, wherein the coupling lever is arranged at least partially in the central region of the housing.

21. The valve gun in accordance with claim 1, wherein the coupling lever is pivotably mounted on a housing of the valve.

22. The valve gun in accordance with claim 1, wherein the valve gun comprises at least one locking member which is movable back and forth between a first position and a second position, the triggering lever being lockable in the first position and releasable in the second position by the at least one locking member.

23. The valve gun in accordance with claim 22, wherein the valve gun comprises a first and a second locking member which are each movable back and forth between a first position and a second position.

24. The valve gun in accordance with claim 22, wherein at least one locking member is movably mounted on a grip, graspable by the user with his hand, of the housing.

25. The valve gun in accordance with claim 22, wherein a locking member, in the first position, protrudes from a front side of the grip that faces an outlet of the valve.

26. The valve gun in accordance with claim 22, wherein a locking member is movably mounted on a region of the triggering lever which, in the rest position of the triggering lever, protrudes from the grip, the locking member, in its first position, protruding from the triggering lever, and, in its second position, extending fully into the triggering lever.
